(19) United States
(12) Patent Application Publication
(10) Pub. No.: US 2005/0088858 A1
(43) Pub. Date: Apr. 28, 2005

(54) Power supply unit comprising a switched-mode power supply

(76) Inventors: Reinhard Kogel, Brigachtal (DE); Jean-Paul Louvel, Brigachtal (DE); Eugen Kizmann, Villingen-Schwenningen (DE)

Correspondence Address: Joseph S Tripoli;Patent Operations, Thomson Licensing Inc, Two Independence Way, Princeton, NJ, 08543-5312, US

(21) Appl. No.: 10/505,044

(22) PCT Filed: Feb. 13, 2003
(86) PCT No.: PCT/EP03/01416

(30) Foreign Application Priority Data
Feb. 23, 2002 (DE) 102 07 752.5
May 16, 2002 (DE) 102 21 710.6

(51) Int. Cl. H02M 3/335

(52) U.S. Cl. 363/22

(57) ABSTRACT

The power supply unit comprises a switched-mode power supply which has a transformer (TR1) with a primary winding (W1) and a multitude of secondary windings (W2, W3), a switching transistor (T1) which is coupled to the primary winding (W1) and a control circuit by means of which an output voltage (U2) from the switched-mode power supply can be stabilized on the flyback converter principle. The power supply also comprises a switching regulator (7) which is connected to a secondary winding (W3) which supplies a positive voltage (U3) when the switching transistor (T1) is in the switched-on phase. The output voltage (U4) which is produced by the switching regulator is used in particular for operation of a low-noise converter (LNB). In one preferred embodiment, the switched-mode regulator (7) is a step-down converter, and the secondary winding (W3) supplies a rectified output voltage (U4) via a rectifier means (D4), the value of which output voltage (U4) is preferably in a range from 25 to 50 volts. This allows to compensate for brief interruptions in the mains voltage.

### FIELD OF THE INVENTION

The present invention relates to a power supply unit comprising a switched-mode power supply which has a transformer with a primary winding and a number of secondary windings, as well as a switching transistor coupled to the primary winding, and a control circuit by means of which an output voltage from the switched-mode power supply is stabilized on the flyback converter principle. Power supply units of this type are frequently used in appliances for consumer electronics, for example in television sets and video recorders, in order to produce a multitude of stabilized supply voltages.

### BACKGROUND OD THE INVENTION

Switched-mode power supplies based on the flyback converter principle have stabilized output voltages, with one of the output voltages being regulated via a control loop. The switching transistor is driven via the control loop, which is connected to the driver circuit for the switching transistor, such that the output voltage which is connected to the control loop is kept constant, for example, by means of pulse width modulation (PWM) or by varying the frequency of the control signal for the switching transistor. This also results in the other output voltages from the switched-mode power supply being stabilized, since the output voltages which are produced by the further secondary windings are, to a first approximation, dependent only on the turns ratio between the stabilized winding and the secondary windings.

If an appliance requires a large number of supply voltages, then the switched-mode power supply must have a correspondingly large number of secondary windings to produce these supply voltages. Voltage regulators, in particular linear regulators, are frequently also connected downstream from the secondary winding and can be used to produce a further supply voltage and/or to achieve improved stabilization.

It is also known for a secondary winding which is connected in a forward mode to be used in a switched-mode power supply which operates on the flyback converter principle. In a corresponding manner to a forward converter, this produces an output voltage when the switching transistor that is connected to the primary winding is switched on. The output voltage from this secondary winding is in this case proportional to the input voltage which is applied to the primary winding, depending on the turns ratio of this winding with respect to the primary winding. When the appliance is switched off, or when a brief mains interruption occurs, this, however, has the disadvantage that the output voltage which is produced by the secondary winding drops in a corresponding manner to the input voltage.

DE-A-3912349 discloses a power supply unit in which the voltage at a first output of the transformer is controlled on the flyback converter principle, and the voltage at a second output of the transistor is operated as a forward converter. The discharge time of the transformer is variable in order to control the output voltage of the flyback converter.

### SUMMARY OF THE INVENTION

The object of the present invention is to specify a power supply unit having a switched-mode power supply which has a multitude of output voltages, can be produced at low cost and, in particular, is suitable for use in a set-top box or in an appliance with an integrated satellite decoder.

This object is achieved for a power supply unit by means of the invention as specified in claim 1, for an appliance by that specified in claim 9, for a satellite receiver by that specified in claim 11 and for a television receiver by that specified in claim 12. Advantageous developments of the invention are specified in the dependent claims.

The power supply unit according to the invention has a switched-mode power supply which comprises a transformer with a primary winding and a number of secondary windings, as well as a switching transistor coupled to the primary winding, and a control circuit via which the output voltage from a first secondary winding is stabilized on the flyback converter principle. A second secondary winding of the transformer is operated on the principle of a forward converter. Since the output voltage from this secondary winding is not regulated, and this output voltage depends in particular on the turns ratio between the primary winding and this secondary winding, this output voltage is stabilized by a downstream switching regulator.

In a first embodiment, the switching regulator is a step-down converter, and the output voltage from the second secondary winding is advantageously in a range from 25 to 50 volts, so that the step-down converter still continues its operation in the event of brief mains interruptions.

The power supply unit may be used in particular in an appliance, for example a television set, or in a set-top box, with the secondary winding which is connected on the principle of a forward converter, preferably producing a supply voltage for a hard disk or for operation of a low-noise converter.

In a second embodiment, the switching regulator is a step-up converter, and the output voltage from the second secondary winding is in a range from 5 to 15 volts.

The stabilized output voltage obtained in this way can be used in particular for operation of a low-noise converter. Since low-noise converters in a satellite receiver frequently require two supply voltages, switchable between 13 volts and 18 volts, the control for the step-up converter can be designed accordingly.

The use of a secondary winding, which is operated in a forward mode, has the advantage that the transformer is not loaded by this winding, since the power which is transmitted for this winding does not result in magnetization of the transformer core. Since the switched-mode power supply operates on the flyback converter principle, this output voltage is, however, not stabilized and is dependent in particular on mains voltage fluctuations. However, this is not a disadvantage since this output voltage is used in particular for operation of a low-noise converter, which alternatively requires two different supply voltages. These two supply voltages can advantageously be produced by a step-down converter or a step-up converter from the output voltage from this secondary winding, by appropriately switching the control circuit for this converter depending on the output voltage that is required.

### BRIEF DESCRIPTION OF THE DRAWINGS

The invention will be explained in more detail in the following text with reference to schematic circuit diagrams, by way of example, in which:

FIG. 1 shows a power supply unit having a switched-mode power supply and a step-down converter,

FIG. 2 shows an exemplary embodiment of a step-down converter as shown in FIG. 1,

FIG. 3 shows a power supply unit having a switched-mode power supply and a step-up converter.

### DETAILED DESCRIPTION OF PREFERRED EMBODIMENTS

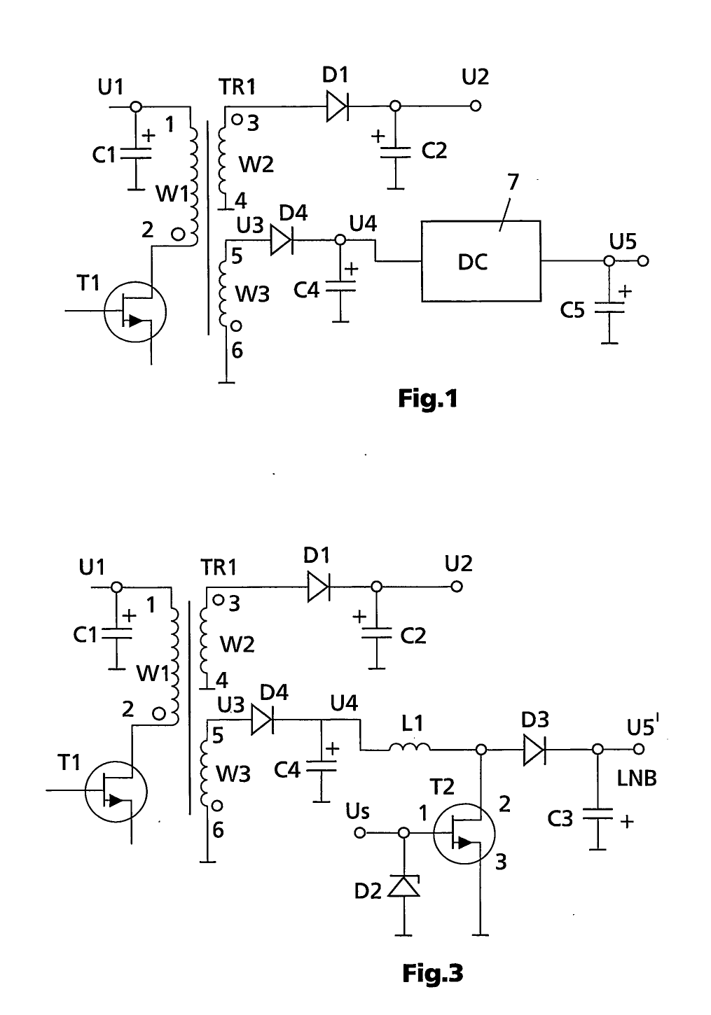

The power supply unit shown in FIG. 1 comprises a switched-mode power supply having a transformer TR1 which has a primary winding W1 and secondary windings W2 and W3 arranged on the secondary side, in order to produce output voltages U2 and U3 respectively. A DC voltage U1, which is provided by an energy-storage capacitor C1, is connected to a terminal 1 of the primary winding W1. A switching transistor T1 is connected to a second terminal 2 of the primary winding W1 and allows power to be transmitted from the primary winding W1 to the secondary windings W2 and W3. In this embodiment, the switching transistor T1 is connected in series with the primary winding W1 and is operated in the flyback converter mode in order to stabilize the output voltage U2, in which mode a positive voltage for charging a capacitor C2 is supplied via a diode D1 from the secondary winding W2 during the phase in which the switching transistor T1 is switched off.

The switched-mode power supply unit as shown in FIG. 1 is a simplified illustration with, for example, inter alia, no driver circuit or protection circuits for the switching transistor T1 being shown, since these are known from the prior art and are not the subject matter of this invention. Transformers that are used in practice likewise have a considerably more complex design, and normally have further secondary windings both on the primary side and on the secondary side. If the switched-mode power supply is operated with a DC voltage U1, which is produced via a rectifier from a mains voltage, then the transformer TR1 is in the form of an isolating transformer. However, the switched-mode power supply can also be used as a battery-powered DC/DC converter, so that there is no need for mains isolation. If the switched-mode power supply is operated with a mains voltage, then, in particular, it may have special circuits for power factor correction.

The switching transistor T1 may in this case be controlled via an auxiliary winding arranged on the primary side or via control on the secondary side, in which case the control circuit regulates one of the output voltages on the secondary side of the switched-mode power supply via a control loop. The switching transistor is in this case operated in the flyback converter mode, in which energy is stored via the primary winding W1 in the transformer TR1 during the phase in which the switching transistor T1 is switched on, and this energy is then transmitted to one or more secondary windings, in this case to the secondary winding W2, in the phase when the switching transistor T1 is switched off.

The two windings W1 and W2 are in this case wound in the sense such that voltages with same polarity are produced at the terminals 2 and 3. Terminals with same polarities are indicated by a dot in the FIGS. 1 and 3. If, for example, the transistor T1 is switched off during normal operation of the switched-mode power supply, then the voltage at the terminal 2 is high in comparison to the voltage at the terminal 1 owing to the inductance of the transformer TR1 and, at the same time, the voltage at the terminal 3 of the winding W2 is high in comparison to that at the terminal 4. Since, in consequence the diode D1 is forward-biased, the capacitor C2 is charged during the phase in which the transistor T1 is switched off, thus resulting in a positive supply voltage U2.

The DC voltage U2 is regulated as follows on the flyback converter principle: the voltage U2 is compared via a voltage divider with a stable reference voltage, and any discrepancy from the nominal value is transmitted to the primary side of the switched-mode power supply for example via an opto-coupler. In the driver circuit for the switching transistor T1, this discrepancy is used to drive the switching transistor. One type of driver that is frequently used is in this case a pulse-width modulated drive, in which the power is transmitted in the transformer TR1 by varying the pulse width of the control signal for the switching transistor T1. A switched-mode power supply whose output voltage is regulated on the secondary side is described, for example, in U.S. Pat. No. 4,876,636, which is hereby referred to. However, the switching transistor T1 may also be controlled by control arranged on the primary side.

One advantage of the flyback converter principle is that the transformer TR1 may have further secondary windings, each having a downstream diode and a capacitor in order to produce further output voltages which are likewise stabilized. The output voltage from a further secondary winding in this case depends on the number of turns of this winding in comparison to the number of turns on the winding W2, and is essentially proportional to the turns ratio.

The transformer. TR1 also has a winding W3, whose winding sense is the opposite to that of the winding W2. The winding sense of one winding is indicated by a circle in the figure, with connections having a circle in this case having the same voltage mathematical signs during operation. A positive voltage U3 is thus produced at the connection 5 of the winding W3 in the phase when the switching transistor T1 is switched on, and a negative voltage is produced there during the phase in which it is switched off, in contrast to the voltage at the connection 3 of the winding W2. The voltage U3 is rectified by a diode D4 and is smoothed by a capacitor C4 in order to produce a positive voltage U4, which is used by a downstream step-down regulator 7 to produce a stabilized supply voltage U5.

The power in this case is thus transmitted from the winding W1 to the winding W3, during the phase in which the switching transistor T1 is switched on, thus corresponding to a forward mode. The voltage across the secondary winding W3 is in this case proportional to the voltage across the primary winding W1. In consequence, power is not transmitted by magnetization of the transformer core, as in the flyback converter principle. The transformer TR1, which is operated in the flyback converter mode, produces the output power for the secondary winding W3 to a certain extent as a by-product, and a transformer core is not loaded by this. If the winding W3 were likewise operated in the flyback converter mode, then the transformer TR1 would need to be designed for a higher output power, and would need to be designed correspondingly larger.

The turns ratio W3 to W1 is in this case such that the output voltage U4 which is produced across the capacitor C4 is greater than 25 volts during normal operation, preferably in a range from 30 to 50 volts. In consequence, the step-down converter 7 still continues to operate during brief interruptions in the mains voltage, and interruptions of up to 50 milliseconds are tolerated. The output voltage U5 which is produced by the step-down converter is, for example, 12 volts or less.

Another possible way to bridge brief mains voltage interruptions would be to use a considerably larger energy storage capacitor C1. This is avoided in this case by using a comparatively high output voltage U4 in conjunction with a downstream step-down converter.

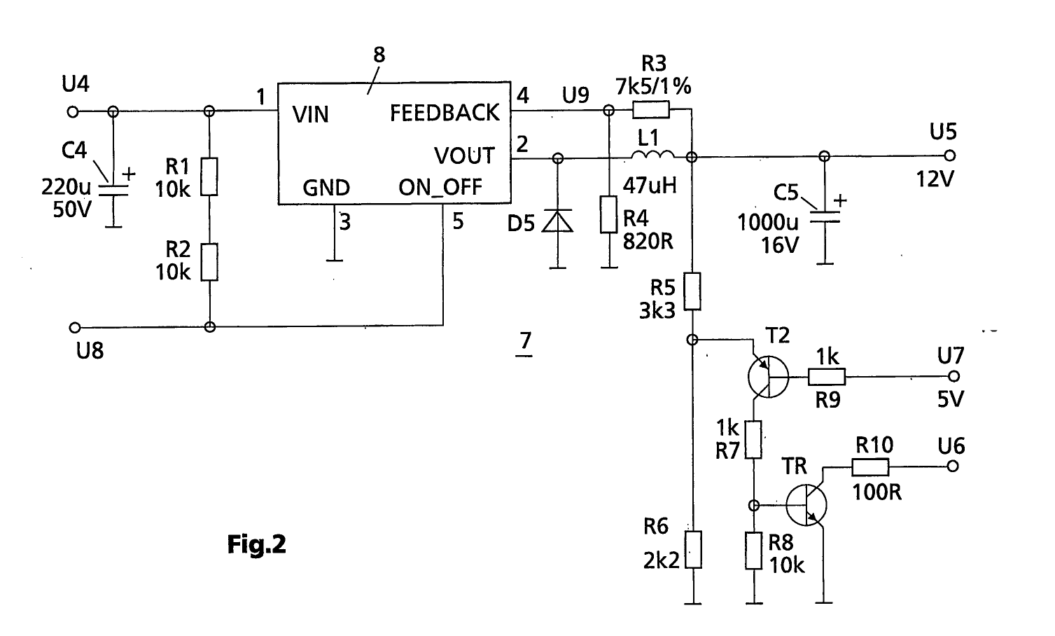

A special embodiment of the step-down converter 7 is shown in FIG. 2. In this embodiment an integrated circuit 8, for example an IC LM2576 from National Semiconductor, is used, which has an internal switching transistor, as well as an oscillator, a control circuit and a driver station for this switching transistor. The input of the integrated circuit 8 is connected to the capacitor C4 in FIG. 1 and the output Vout is connected to a coil L1, whose output is connected to the capacitor C5. A control signal U9 is tapped off the capacitor C5 via two resistors R3 and R4, and is applied to the feedback input of the integrated circuit 8, in order to regulate the voltage U5. Furthermore, a freewheeling diode D5 is connected to earth between the output Vout of the integrated circuit 8 and that of the coil L1.

Furthermore the integrated circuit 8 also has an ON_OFF input, via which the integrated circuit 8 can be switched off by means of a voltage U5, for example for a standby mode.

The circuit operates as follows, the switching transistor which is contained in the integrated circuit 8 is controlled as a function of the control signal U9. If the output voltage U5 falls below a specific threshold value, then the switching transistor is opened, resulting in a magnetic field being built up in the coil L1. When the switching transistor in the integrated circuit is switched off, the coil L1 is then discharged via the freewheeling diode D5 and in consequence charges the capacitor C5. This switching cycle is carried out periodically at the switching frequency of the internal oscillator in the integrated circuit 8. The output voltage U5 may in this case be stabilized, for example, with a tolerance of less than 4%.

The voltage U5 may be used in particular for operating a hard disk in a television or in a set-top box. A hard disk requires a voltage of 12 volts in order to operate the hard disk drive. At the same time, the voltage U5 can be used for operation of a low-noise converter (LNC), which requires an operating voltage of 13 and 18 volts. These voltages-can be produced from the 12 volts in a simple manner, for example by means of a switchable step-up converter.

The step-down converter 7 also has an overvoltage protection circuit with two transistors T2 and T3. A portion of the output voltage U5 is in this case applied to the emitter of the transistor T2 via a voltage divider formed by resistors R5 and R6. At the same time, a voltage U7 of 5 volts is applied to the base of the transistor T2, and the collector of the transistor T2 is connected to earth via two resistors, R7 and R8. In consequence, the transistor T2 is switched on at a threshold value of about 5.7 volts.

If the voltage U5 is too high, then the transistor T2 is switched on, depending on the resistance ratio R5 to R6, and in consequence the transistor T3 is likewise switched on, with its base being connected to a tap between the two resistors, R7 and R8. In consequence, the step-down converter 7 can be switched off by the output voltage U6 from the transistor T3 in the event of an overvoltage.

A particularly cost-effective power supply unit having a switched-mode power supply and a downstream step-up converter is illustrated in FIG. 3. The same reference symbols are used in this case for circuit elements and voltages in FIG. 3 which correspond to those in FIG. 1.

The switched-mode power supply shown in FIG. 3 comprises a transformer TR1 which has a primary winding W1 and secondary windings W2 and W3, arranged on the secondary side, in order to produce output voltages U2 and U3, respectively. On the primary side, the switched-mode power supply shown in FIG. 3 is constructed in a corresponding manner to the switched-mode power supply shown in FIG. 1, and is likewise operated in the flyback converter mode in order to stabilize the output voltage U2, in which mode the secondary winding W2 produces a voltage during the phase when the switching transistor T1 is switched off, in order to charge a capacitor C2 via a diode D1, as explained above.

The transformer TR1 also has a winding W3 which is arranged and connected in a corresponding manner to the winding W3 of the transformer TR1 in FIG. 1, and which produces a positive voltage when the switching transistor T1 is in the switched-on phase. The voltage U3 is rectified by a diode D4 and is smoothed by a capacitor C4 in order to produce a positive voltage U4. In this case, the way in which the power is transmitted from the winding W1 to the winding W3 likewise corresponds to a forward mode.

In this embodiment, the capacitor C4 is followed by a step-up converter with a switching transistor T2 in order to produce a stabilized supply voltage U5′. The step-up converter has a coil L1, one end of which is connected to the capacitor C4 while its other end is connected via a diode D3 to a capacitor C3, across which the supply voltage U5′ can be tapped off. The switching transistor T2 is coupled between the coil L1 and the diode D3 and is connected to earth. It is driven by means of a pulse-width modulator control signal Us in a known manner by means of a control circuit, although this is not illustrated in FIG. 3, in order to produce and stabilize the supply voltage U5′. When the transistor T2 is switched on, then magnetization builds up in the coil L1 which, when the transistor T2 is in the switched-off phase, produces a current in order to charge the capacitor C3. The supply voltage U5′ is in consequence, in particular, higher than the voltage U4.

The inductance of the coil L1 thus makes it possible to use a pulse-width modulated drive for the transistor T2 to produce supply voltages U5′ which are regulated. If, for example, voltages of 13 volts and 18 volts are required as the supply voltage U5′, then the ratio of the number of turns on the winding W3 to the number of turns on the primary winding W1 is chosen such that the voltage range of the positive component of the voltage U3 is in a range from 5 to 15 volts. This voltage range can be regulated out by a step-up converter without any problems.

The winding W3 is thus likewise used together with the circuitry shown in FIG. 3 in a corresponding manner to a forward converter. As already explained above, the disadvantage in this case is that the positive component of the AC voltage U3 depends on the voltage U1 across the winding W1 and, in consequence, is particularly dependent on fluctuations in the mains voltage, when the voltage U1 is produced via the mains voltage.

However, this is not a disadvantage in this case, since the supply voltage U5′ which is produced from the upward voltage U3 is in any case stabilized by the step-up converter. Possible voltage fluctuations of for example ±10% in the 230 volts mains voltage thus do not represent a problem. A low-noise converter, LNB, for a satellite antenna normally requires two different operating voltages, depending on its operating mode. By choosing one specific operating voltage, a desired polarization of the received satellite signal can be selected, in particular, via the LNB. This voltage may in consequence be selected as required in a simple manner, by means of the step-up converter. The step-up converter may in this case be designed with a switching stage in discrete form, as explained with reference to the figure, or else may be in the form of an integrated circuit.

The present invention is not limited to the embodiments as shown and described above, and various modifications are within the scope of a person skilled in the art without departing from the invention. In particular, the invention is not restricted to the specific embodiment of the flyback converter described here and may also be used also for flyback converters having two or more switching transistors on the primary side.

1. Power supply unit comprising a switched-mode power supply having
a transformer with a primary winding and a number of secondary windings,
a switching transistor coupled to the primary winding and
a control circuit by means of which an output voltage from a first secondary winding is stabilized on the flyback converter principle,
a second secondary winding being connected in a forward mode, which is followed by a switching regulator wherein switching regulator is a step-down converter,
that the second secondary winding produces a rectified output voltage via a rectifier means, preferably a diode, the value of which output voltage during normal operation is in a range from 30 to 50 volts, and that the step-down converter produces a stabilized output voltage of less than or equal to 16 V, in order to bridge mains voltage dips.

2. Power supply unit according to claim 1, wherein the turns ratio of the second secondary winding with respect to the primary winding is chosen such that the output voltage from the second secondary winding produces a rectified voltage in a range from 30 to 50 volts.

3. Power supply unit according to claim 1, wherein the output voltage which is produced by the switched-mode regulator is used to operate a low-noise converter.

4. Power supply unit according to claim 3, wherein the switching regulator has a control circuit for producing different output voltages for operation of the low-noise converter.
